(19) United States
(12) Patent Application Publication
(10) Pub. No.: US 2026/0247240 A1
(43) Pub. Date: Aug. 20, 2026

(54) METHOD AND APPARATUS FOR SWITCHING BETWEEN SINGLE TRP AND MULTIPLE TRPS

(71) Applicants: HYUNDAI MOTOR COMPANY, Seoul (KR); Kia Corporation, Seoul (KR)

(72) Inventors: Jeong Su Lee, Hwaseong-si, Gyeonggi-do (KR); Ui Hyun Hong, Hwaseong-si, Gyeonggi-do (KR); Young Kil Suh, Hwaseong-si, Gyeonggi-do (KR); Gene Back Hahn, Hwaseong-si, Gyeonggi-do (KR)

(73) Assignees: HYUNDAI MOTOR COMPANY, Seoul (KR); Kia Corporation, Seoul (KR)

(21) Appl. No.: 19/471,170

(22) PCT Filed: May 8, 2024
(86) PCT No.: PCT/KR2024/006126

§ 371 Date: Sep. 30, 2025

(30) Foreign Application Priority Data
May 11, 2023 (KR) 10-2023-0061253

(51) Int. Cl. H04W 36/08; H04B 7/06; H04W 72/231; H04W 76/20; H04W 80/02

(52) U.S. Cl. CPC H04W 36/08; H04B 7/06968; H04W 72/231; H04W 76/20; H04W 80/02

(57) ABSTRACT

Disclosed are a method and apparatus for switching between a single TRP and multiple TRPs. The method of a UE comprises the steps of: performing a first TRP communication with a base station; receiving TRP switching information from the base station; performing a TRP switching operation, from the first TRP communication to a second TRP communication, on the basis of the TRP switching information; and performing the second TRP communication with the base station.

### TECHNICAL FIELD

The present disclosure relates to an enhanced communication technique, and more particularly, to a technique for switching operations between a single transmission and reception point (TRP) and multiple TRPs.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, multiple transmission and reception points (mTRP) may be introduced into a communication network (e.g., 5G communication network and/or 6G communication network). The mTRP may be geographically separated. A base station may perform communication with a terminal using the mTRP. mTRP technology may be used to solve a quality of service (QoS) degradation problem of a cell-edge terminal and/or an inter-cell interference problem. In an environment where a non-line-of-sight (NLOS) path is limited, the mTRP technology may be used to provide an additional communication path.

mTRP-based communication may be performed based on a coherent joint transmission (CJT) scheme or a non-CJT (NCJT) scheme. In the CJT scheme, the mTRP may perform cooperative communication based on a stable backhaul link, and the mTRP may provide synchronized communication services to the terminal. In the NCJT scheme, the mTRP may provide communication services to the terminal without cooperation. For example, in the NCJT scheme, the mTRP may perform operations such as scheduling operations, precoding matrix selection operations, and modulation and coding scheme (MCS) determination operations without cooperation.

In the communication network, a TRP switching operation between mTRP communication and single-TRP (sTRP) communication may be required. The TRP switching operation may refer to a switching operation from mTRP communication to sTRP communication and/or a switching operation from sTRP communication to mTRP communication. A signaling method for the TRP switching operation may be required. Operations of communication nodes (e.g., a base station, a terminal) according to the signaling (e.g., indication) for the TRP switching operation need to be defined.

### DISCLOSURE

### Technical Problem

The present disclosure is directed to providing a method and an apparatus for switching operations between a single transmission and reception point (TRP) and multiple TRPs.

### Technical Solution

A method of a user equipment (UE), according to exemplary embodiments of the present disclosure for achieving the above-described objective, may comprise: performing a first transmission reception point (TRP) communication with a base station; receiving TRP switching information from the base station; performing a TRP switching operation from the first TRP communication to a second TRP communication based on the TRP switching information; and performing the second TRP communication with the base station, wherein, when the first TRP communication is multiple-TRP (mTRP) communication, the second TRP communication is single-TRP (sTRP) communication, and when the first TRP communication is sTRP communication, the second TRP communication is mTRP communication.

The TRP switching information may be received through at least one of a radio resource control (RRC) message, a medium access control (MAC) control element (CE), or downlink control information (DCI).

The TRP switching operation from the first TRP communication to the second TRP communication may be performed in a UE-specific manner, and a configuration for the TRP switching operation may be a cell group-common configuration or a cell group-specific configuration.

The TRP switching operation from the first TRP communication to the second TRP communication may be performed in a channel-common manner or a channel-specific manner.

The method may further comprise: transmitting information indicating whether the UE supports the TRP switching operation to the base station.

The method may further comprise: receiving, from the base station, information indicating enable, layer 1 (L1)-enable, layer 2 (L2)-enable, or disable of the TRP switching operation, wherein the L1-enable may indicate that the TRP switching operation is enabled by a DCI, and the L2-enable may indicate that the TRP switching operation is enabled by a MAC CE.

The TRP switching information may include a TRP switching indication, a first value of the TRP switching indication may indicate a TRP switching operation from mTRP communication to sTRP communication, and a second value of the TRP switching indication may indicate a TRP switching operation from sTRP communication to mTRP communication.

The TRP switching information may include a bitmap, each bit of the bitmap may be mapped to one TRP or a TRP group, a first value of each bit may indicate an ON state of a TRP or a TRP group mapped to each bit, a second value of each bit may indicate an OFF state of a TRP or a TRP group mapped to each bit, and a TRP group may include a plurality of TRPs.

The TRP switching information may include a follow/unfollow indication, a first value of the follow/unfollow indication may indicate that the second TRP communication follows an indication of a transmission configuration indicator (TCI) selection field included in a DCI received from the base station, and a second value of the follow/unfollow indication may indicate that the second TRP communication does not follow the indication of the TCI selection field included in the DCI received from the base station.

The TRP switching information may include a TRP switching offset, and the second TRP communication may be performed after the TRP switching offset from a time of receiving the TRP switching information.

The TRP switching information may include channel indication information, the TRP switching operation from the first TRP communication to the second TRP communication may be applied to a channel indicated as ON by the channel indication information, and may not be applied to a channel indicated as OFF by the channel indication information.

When a TRP switching operation from mTRP communication to sTRP communication is indicated, the sTRP communication may be performed via a TRP associated with a control resource set (CORESET) 0.

When a TRP switching operation from mTRP communication to sTRP communication is indicated, the sTRP communication may be performed via a TRP associated with a TCI state having a lowest or highest index among TCI states indicated by a TCI field included in a DCI received from the base station.

A method of a base station, according to exemplary embodiments of the present disclosure for achieving the above-described objective, may comprise: performing first transmission reception point (TRP) communication with a user equipment (UE); transmitting TRP switching information to the UE; performing a TRP switching operation from the first TRP communication to a second TRP communication based on the TRP switching information; and performing the second TRP communication with the UE, wherein when the first TRP communication is multiple-TRP (mTRP) communication, the second TRP communication is single-TRP (sTRP) communication, and when the first TRP communication is sTRP communication, the second TRP communication is mTRP communication.

The TRP switching information may be transmitted through at least one of a radio resource control (RRC) message, a medium access control (MAC) control element (CE), or downlink control information (DCI).

The method may further comprise: receiving, from the UE, information indicating whether the UE supports the TRP switching operation, wherein when the UE supports the TRP switching operation, the TRP switching information may be transmitted to the UE.

The TRP switching information may include a TRP switching indication, a first value of the TRP switching indication may indicate a TRP switching operation from mTRP communication to sTRP communication, and a second value of the TRP switching indication may indicate a TRP switching operation from sTRP communication to mTRP communication.

The TRP switching information may include a bitmap, each bit of the bitmap may be mapped to one TRP or a TRP group, a first value of each bit may indicate an ON state of a TRP or a TRP group mapped to each bit, a second value of each bit may indicate an OFF state of a TRP or a TRP group mapped to each bit, and a TRP group may include a plurality of TRPs.

When a TRP switching operation from mTRP communication to sTRP communication is indicated, the sTRP communication may be performed via a TRP associated with a control resource set (CORESET) 0.

When a TRP switching operation from mTRP communication to sTRP communication is indicated, the sTRP communication may be performed via a TRP associated with a TCI state having a lowest or highest index among TCI states indicated by a TCI field included in a DCI received from the base station.

### Advantageous Effects

According to the present disclosure, a unified transmission configuration indicator (TCI) configuration for mTRP communication can be supported, and a TRP switching operation (e.g., dynamic TRP switching operation) between mTRP communication and sTRP communication can be supported. A base station can transmit TRP switching information to a terminal. The terminal may perform a TRP switching operation based on the TRP switching information received from the base station. The TRP switching operation may be performed for entire channels or for each channel. A conflict problem between the TRP switching operation and the TCI configuration may occur. In this case, the terminal can select TRP(s) based on predefined rules, and perform communication via the selected TRP(s). Therefore, the conflict problem between the TRP switching operation and TCI configuration can be resolved.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of communication nodes performing communication.

FIG. 4A is a block diagram illustrating a first exemplary embodiment of a transmission path.

FIG. 4B is a block diagram illustrating a first exemplary embodiment of a reception path.

FIG. 5 is a conceptual diagram illustrating a first exemplary embodiment of a system frame in a communication system.

FIG. 6 is a conceptual diagram illustrating a first exemplary embodiment of a subframe in a communication system.

FIG. 7 is a conceptual diagram illustrating a first exemplary embodiment of a slot in a communication system.

FIG. 8 is a conceptual diagram illustrating a first exemplary embodiment of a time-frequency resource in a communication system.

FIG. 9A is a conceptual diagram illustrating operation methods of a terminal in a situation in which a TCI configuration and a TRP switching indication conflict.

FIG. 9B is a conceptual diagram illustrating operation methods of a terminal in a situation in which a TCI configuration and a TRP switching indication conflict.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. In other words, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

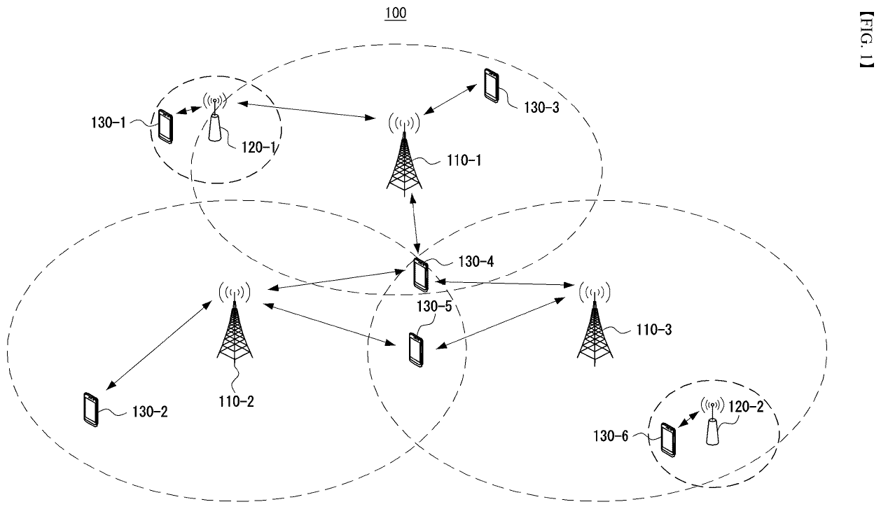

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g., a serving gateway (S-GW), a packet data network (PDN) gateway (P-GW), a mobility management entity (MME). When the communication system 100 is a 5G communication (e.g., NR system), the core network may include an access and mobility management function (AMF), a user plane function (UPF), a session management function (SMF), and the like.

The plurality of communication nodes 110 to 130 may support communication protocols (e.g., LTE communication protocol, LTE-A communication protocol, NR communication protocol, etc.) specified in 3^{rd} generation partnership project (3GPP) standards. The plurality of communication nodes 110 to 130 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

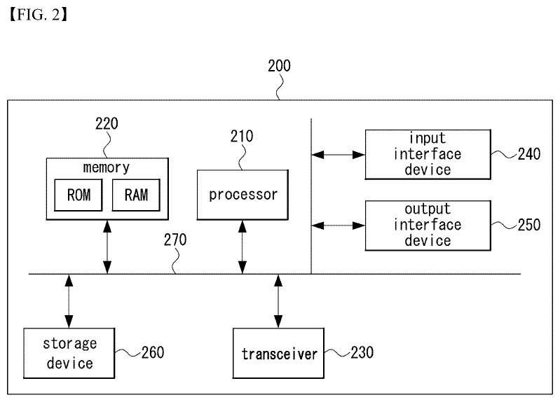

FIG. 2 is a block diagram illustrating a first exemplary embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, sidelink communication (e.g., device-to-device (D2D) communication, proximity services (ProSe)), Internet of Things (IoT) communication, dual connectivity (DC), and/or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control sidelink communications between the fourth terminal 130-4 and the fifth terminal 130-5, and thus the fourth terminal 130-4 and the fifth terminal 130-5 may perform the sidelink communications under control of the second base station 110-2 and the third base station 110-3, respectively.

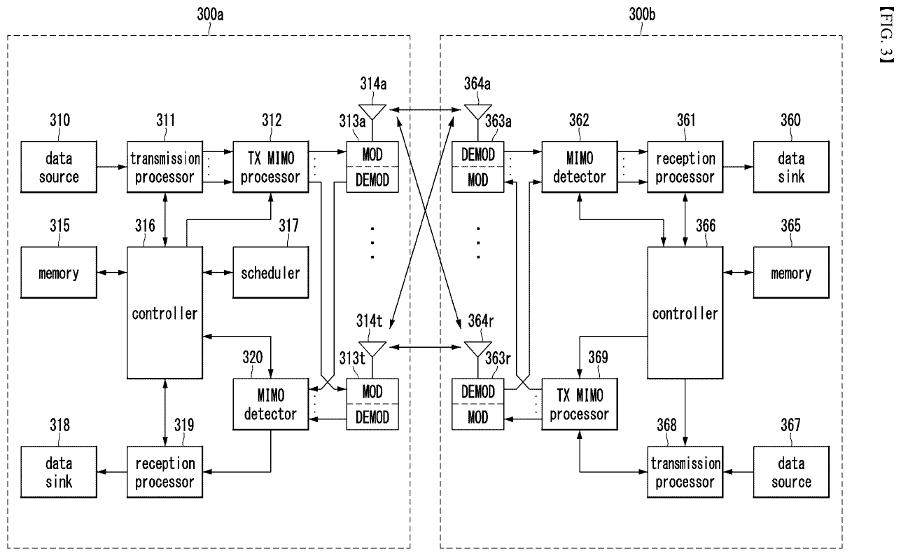

Meanwhile, communication nodes that perform communications in the communication network may be configured as follows. A communication node shown in FIG. 3 may be a specific exemplary embodiment of the communication node shown in FIG. 2.

FIG. 3 is a block diagram illustrating a first exemplary embodiment of communication nodes performing communication.

As shown in FIG. 3, each of a first communication node 300a and a second communication node 300b may be a base station or UE. The first communication node 300a may transmit a signal to the second communication node 300b. A transmission processor 311 included in the first communication node 300a may receive data (e.g., data unit) from a data source 310. The transmission processor 311 may receive control information from a controller 316. The control information may include at least one of system information, RRC configuration information (e.g., information configured by RRC signaling), MAC control information (e.g., MAC CE), or PHY control information (e.g., DCI, SCI).

The transmission processor 311 may generate data symbol(s) by performing processing operations (e.g., encoding operation, symbol mapping operation, etc.) on the data. The transmission processor 311 may generate control symbol(s) by performing processing operations (e.g., encoding operation, symbol mapping operation, etc.) on the control information. In addition, the transmission processor 311 may generate synchronization/reference symbol(s) for synchronization signals and/or reference signals.

A Tx MIMO processor 312 may perform spatial processing operations (e.g., precoding operations) on the data symbol(s), control symbol(s), and/or synchronization/reference symbol(s). An output (e.g., symbol stream) of the Tx MIMO processor 312 may be provided to modulators (MODs) included in transceivers 313a to 313t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 313a to 313t may be transmitted through antennas 314a to 314t.

The signals transmitted by the first communication node 300a may be received at antennas 364a to 364r of the second communication node 300b. The signals received at the antennas 364a to 364r may be provided to demodulators (DEMODs) included in transceivers 363a to 363r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 362 may perform MIMO detection operations on the symbols. A reception processor 361 may perform processing operations (e.g., de-interleaving operation, decoding operation, etc.) on the symbols. An output of the reception processor 361 may be provided to a data sink 360 and a controller 366. For example, the data may be provided to the data sink 360 and the control information may be provided to the controller 366.

On the other hand, the second communication node 300b may transmit signals to the first communication node 300a. A transmission processor 368 included in the second communication node 300b may receive data (e.g., data unit) from a data source 367 and perform processing operations on the data to generate data symbol(s). The transmission processor 368 may receive control information from the controller 366 and perform processing operations on the control information to generate control symbol(s). In addition, the transmission processor 368 may generate reference symbol(s) by performing processing operations on reference signals.

A Tx MIMO processor 369 may perform spatial processing operations (e.g., precoding operations) on the data symbol(s), control symbol(s), and/or reference symbol(s). An output (e.g., symbol stream) of the Tx MIMO processor 369 may be provided to modulators (MODs) included in the transceivers 363a to 363t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 363a to 363t may be transmitted through the antennas 364a to 364t.

The signals transmitted by the second communication node 300b may be received at the antennas 314a to 314r of the first communication node 300a. The signals received at the antennas 314a to 314r may be provided to demodulators (DEMODs) included in the transceivers 313a to 313r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 320 may perform a MIMO detection operation on the symbols. The reception processor 319 may perform processing operations (e.g., de-interleaving operation, decoding operation, etc.) on the symbols. An output of the reception processor 319 may be provided to a data sink 318 and the controller 316. For example, the data may be provided to the data sink 318 and the control information may be provided to the controller 316.

Memories 315 and 365 may store the data, control information, and/or program codes. A scheduler 317 may perform scheduling operations for communication. The processors 311, 312, 319, 361, 368, and 369 and the controllers 316 and 366 shown in FIG. 3 may be the processor 210 shown in FIG. 2, and may be used to perform methods described in the present disclosure.

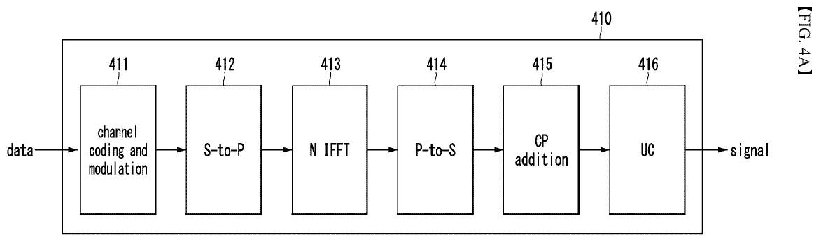

FIG. 4A is a block diagram illustrating a first exemplary embodiment of a transmission path, and FIG. 4B is a block diagram illustrating a first exemplary embodiment of a reception path.

As shown in FIGS. 4A and 4B, a transmission path 410 may be implemented in a communication node that transmits signals, and a reception path 420 may be implemented in a communication node that receives signals. The transmission path 410 may include a channel coding and modulation block 411, a serial-to-parallel (S-to-P) block 412, an N-point inverse fast Fourier transform (N-point IFFT) block 413, a parallel-to-serial (P-to-S) block 414, a cyclic prefix (CP) addition block 415, and up-converter (UC) 416. The reception path 420 may include a down-converter (DC) 421, a CP removal block 422, an S-to-P block 423, an N-point FFT block 424, a P-to-S block 425, and a channel decoding and demodulation block 426. Here, N may be a natural number.

In the transmission path 410, information bits may be input to the channel coding and modulation block 411. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 411 may be a sequence of modulation symbols.

The S-to-P block 412 may convert frequency domain modulation symbols into parallel symbol streams to generate N parallel symbol streams. N may be the IFFT size or the FFT size. The N-point IFFT block 413 may generate time domain signals by performing an IFFT operation on the N parallel symbol streams. The P-to-S block 414 may convert the output (e.g., parallel signals) of the N-point IFFT block 413 to serial signals to generate the serial signals.

The CP addition block 415 may insert a CP into the signals. The UC 416 may up-convert a frequency of the output of the CP addition block 415 to a radio frequency (RF) frequency. Further, the output of the CP addition block 415 may be filtered in baseband before the up-conversion.

The signal transmitted from the transmission path 410 may be input to the reception path 420. Operations in the reception path 420 may be reverse operations for the operations in the transmission path 410. The DC 421 may down-convert a frequency of the received signals to a baseband frequency. The CP removal block 422 may remove a CP from the signals. The output of the CP removal block 422 may be serial signals. The S-to-P block 423 may convert the serial signals into parallel signals. The N-point FFT block 424 may generate N parallel signals by performing an FFT algorithm. The P-to-S block 425 may convert the parallel signals into a sequence of modulation symbols. The channel decoding and demodulation block 426 may perform a demodulation operation on the modulation symbols and may restore data by performing a decoding operation on a result of the demodulation operation.

In FIGS. 4A and 4B, discrete Fourier transform (DFT) and inverse DFT (IDFT) may be used instead of FFT and IFFT. Each of the blocks (e.g., components) in FIGS. 4A and 4B may be implemented by at least one of hardware, software, or firmware.

For example, some blocks in FIGS. 4A and 4B may be implemented by software, and other blocks may be implemented by hardware or a combination of hardware and software. In FIGS. 4A and 4B, one block may be subdivided into a plurality of blocks, a plurality of blocks may be integrated into one block, some blocks may be omitted, and blocks supporting other functions may be added.

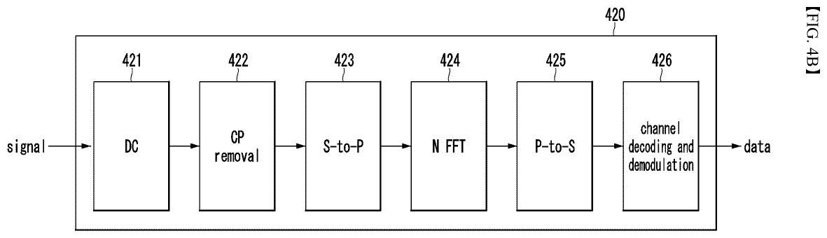

FIG. 5 is a conceptual diagram illustrating a first exemplary embodiment of a system frame in a communication system.

As shown in FIG. 5, time resources in the communication system may be divided on a frame basis. For example, system frames of the communication system may be configured continuously in the time domain. The length of the system frame may be 10 millisecond (ms). A system frame number (SFN) may be set to one of #0 to #1023. In this case, 1024 system frames may be repeated on the time domain of the communication system. For example, an SFN of a system frame after the system frame #1023 may be #0.

One system frame may include two half frames. The length of one half frame may be 5 ms. A half frame located at a starting region of the system frame may be referred to as ‘half frame #0’, and a half frame located at an ending region of the system frame may be referred to as ‘half frame #1’. One system frame may include 10 subframes. The length of one subframe may be 1 ms. 10 subframes within one system frame may be referred to as subframes #0-#9.

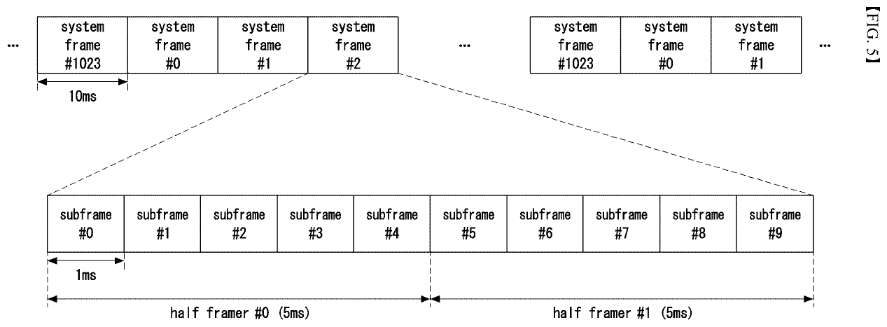

FIG. 6 is a conceptual diagram illustrating a first exemplary embodiment of a subframe in a communication system.

As shown in FIG. 6, one subframe may include n slots, and n may be a natural number. Accordingly, one subframe may consist of one or more slots.

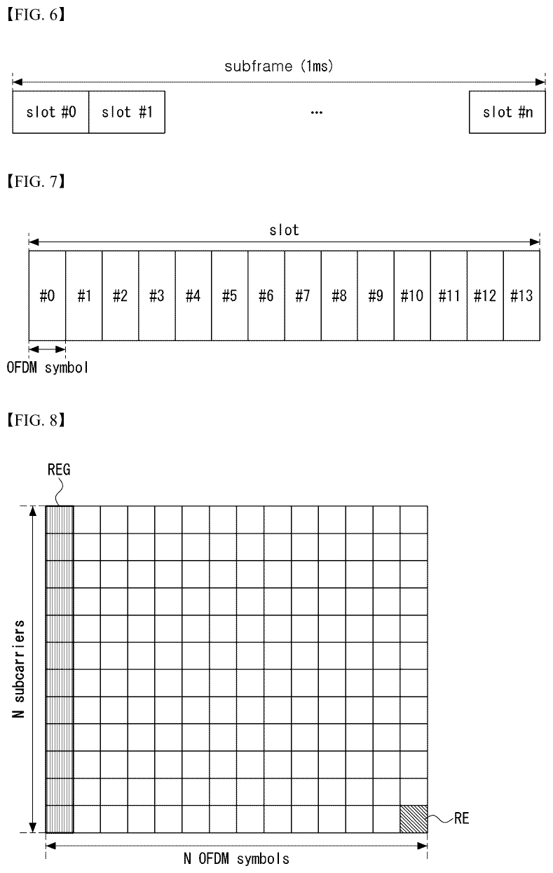

FIG. 7 is a conceptual diagram illustrating a first exemplary embodiment of a slot in a communication system.

As shown in FIG. 7, one slot may include one or more symbols. For example, one slot shown in FIG. 7 may include 14 symbols. The length of slot may vary according to the number of symbols included in a slot and the length of symbol. Alternatively, the length of slot may vary according to a numerology.

The numerology applied to physical signals and channels in a communication system may be variable. The numerology may be adjusted to meet various technical requirements of the communication system. In a communication system where a cyclic prefix (CP)-based OFDM waveform technology is applied, the numerology may include a subcarrier spacing and a CP length (or CP type). Table 1 may illustrate a first exemplary embodiment of a method for configuring numerologies for a CP-OFDM-based communication system. Depending on a frequency band in which the communication system operates, at least some of the numerologies in Table 1 may be supported. Additionally, the communication system may support numerologies not listed in Table 1.

TABLE 1

| | Subcarrier spacing | | | | | |
|---|---|---|---|---|---|---|
| | 15 | 30 | 60 | 120 | 240 | 480 |
| | kHz | kHz | kHz | kHz | kHz | kHz |
| OFDM symbol | 66.7 | 33.3 | 16.7 | 8.3 | 4.2 | 2.1 |
| length [μs] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

When a subcarrier spacing is 15 kHz (e.g., p=0), the length of slot may be 1 ms. In this case, one system frame may include 10 slots. When a subcarrier spacing is 30 kHz (e.g., p=1), the length of slot may be 0.5 ms. In this case, one system frame may include 20 slots.

When a subcarrier spacing is 60 kHz (e.g., p=2), the length of slot may be 0.25 ms. In this case, one system frame may include 40 slots. When a subcarrier spacing is 120 kHz (e.g., p=3), the length of slot may be 0.125 ms. In this case, one system frame may include 80 slots. When a subcarrier spacing is 240 kHz (e.g., p=4), the length of slot may be 0.0625 ms. In this case, one system frame may include 160 slots.

The symbol may be configured as a downlink (DL) symbol, flexible (FL) symbol, or uplink (UL) symbol. A slot composed of only DL symbols may be referred to as a ‘DL slot’, a slot composed of only FL symbols may be referred to as a ‘FL slot’, and a slot composed of only UL symbols may be referred to as a ‘UL slot’.

A slot format may be semi-statically configured through higher-layer signaling (e.g., RRC signaling). Information indicating a semi-static slot format may be included in system information, and the semi-static slot format may be configured cell-specifically. Additionally, a semi-static slot format may be further configured for each terminal through terminal-specific higher-layer signaling (e.g., RRC signaling). Flexible symbols in the cell-specific slot format may be overridden to be downlink symbols or uplink symbols through terminal-specific higher-layer signaling. Furthermore, a slot format may be dynamically indicated through physical layer signaling (e.g., slot format indicator (SFI) included in DCI). The semi-statically configured slot format may be overridden by the dynamically indicated slot format. For example, flexible symbols configured semi-statically may be overridden to be downlink symbols or uplink symbols by the SFI.

Reference signals may include Channel State Information-Reference Signal (CSI-RS), Sounding Reference Signal (SRS), Demodulation-Reference Signal (DMRS), and Phase Tracking-Reference Signal (PT-RS). Channels may include Physical Broadcast Channel (PBCH), Physical Downlink Control Channel (PDCCH), Physical Downlink Shared Channel (PDSCH), Physical Uplink Control Channel (PUCCH), PUSCH (Physical Uplink Shared Channel), PSCCH (Physical Sidelink Control Channel), and PSSCH (Physical Sidelink Shared Channel). In the present disclosure, a control channel may refer to PDCCH, PUCCH, or PSCCH, and a data channel may refer to PDSCH, PUSCH, or PSSCH.

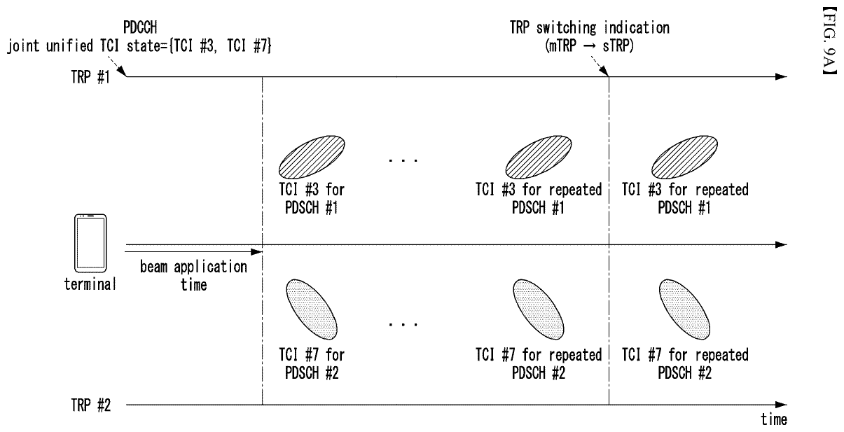

FIG. 8 is a conceptual diagram illustrating a first exemplary embodiment of a time-frequency resource in a communication system.

As shown FIG. 8, a resource composed of one OFDM symbol on the time axis and one subcarrier on the frequency axis may be defined as a ‘resource element (RE)’. A resource composed of one OFDM symbol on the time axis and K subcarriers on the frequency axis may be defined as a ‘resource element group (REG)’. The REG may include K REs. The REG may be used as a basic unit of resource allocation in the frequency domain. K may be a natural number. For example, K may be 12. N may be a natural number. In the slot shown in FIG. 7, N may be 14. N OFDM symbols may be used as a basic unit of resource allocation in the time domain.

In the present disclosure, an RB may refer to a common RB (CRB). Alternatively, an RB may refer to a physical RB (PRB) or a virtual RB (VRB). In a communication system, a CRB may refer to an RB that constitutes a set of contiguous RBs (e.g., a common RB grid) based on a reference frequency (e.g., point A). A carrier and/or bandwidth part may be mapped onto the common RB grid. That is, a carrier and/or bandwidth part may be configured with CRB(s). The RBs or CRBs that constitute a bandwidth part may be referred to as PRBs, and a CRB index may be appropriately converted to a PRB index within the bandwidth part.

Downlink data may be transmitted through a PDSCH. A base station may transmit configuration information (e.g., scheduling information) of the PDSCH to a terminal through a PDCCH. The terminal may obtain the configuration information of the PDSCH by receiving the PDCCH (e.g., Downlink Control Information (DCI)). For example, the configuration information of the PDSCH may include a Modulation Coding Scheme (MCS) used for transmission/reception of the PDSCH, time resource information of the PDSCH, frequency resource information of the PDSCH, and feedback resource information for the PDSCH. The PDSCH may refer to a radio resource where the downlink data is transmitted and received. Alternatively, the PDSCH may refer to the downlink data itself. The PDCCH may refer to a radio resource where the downlink control information (e.g., DCI) is transmitted and received. Alternatively, the PDCCH may refer to the downlink control information itself.

The terminal may perform a monitoring operation for the PDCCH to receive the PDSCH transmitted from the base station. The base station may notify the terminal of configuration information for the PDCCH monitoring operation using a higher-layer message (e.g., Radio Resource Control (RRC) message). The configuration information for the PDCCH monitoring operation may include Control Resource Set (CORESET) information and search space information.

The CORESET information may include PDCCH DMRS information, PDCCH precoding information, and PDCCH occasion information, and the like. A PDCCH DMRS may be a DMRS used for demodulating a PDCCH. A PDCCH occasion refers to a region where a PDCCH may potentially exist, meaning it is a region where DCI can be transmitted. A PDCCH occasion may also be referred to as a PDCCH candidate. The PDCCH occasion information may include time resource information and frequency resource information for the PDCCH occasion. In the time domain, the length of the PDCCH occasion may be indicated in symbol units. In the frequency domain, the size of the PDCCH occasion can be indicated in RB units (e.g., in PRB units or CRB units).

The search space information may include a CORESET identifier (ID) associated with a search space, a periodicity of PDCCH monitoring, and/or an offset of PDCCH monitoring. The periodicity and offset of PDCCH monitoring may each be indicated in slot units. Additionally, the search space information may further include an index of a symbol where the PDCCH monitoring operation starts.

The base station may configure Bandwidth Part(s) (BWP(s)) for downlink communication. The BWP(s) may be configured differently for each terminal. The base station may notify the terminal of BWP configuration information using higher-layer signaling. The higher-layer signaling may refer to a transmission operation of system information and/or a transmission operation of RRC message(s). The number of BWPs configured for a single terminal may be one or more. The terminal may receive the BWP configuration information from the base station and identify the configured BWP(s) based on the received configuration information. When multiple BWPs are configured for downlink communication, the base station may activate one or more BWPs from among the multiple BWPs. The base station may transmit configuration information of the activated BWP(s) to the terminal using at least one of higher-layer signaling, Medium Access Control (MAC) Control Element (CE), or DCI. The base station may perform downlink communication using the activated BWP(s). The terminal may identify the activated BWP(s) by receiving the configuration information from the base station and perform downlink reception operations on the activated BWP(s).

Meanwhile, a communication system (e.g., NR communication system, 5G communication system, or 6G communication system) may support use scenarios such as enhanced Mobile BroadBand (eMBB), Ultra Reliable Low Latency Communication (URLLC), and massive Machine Type Communication (mMTC). The communication system (e.g., communication network) may support a transmission and reception point (TRP) technology (e.g., multi-TRP (mTRP) technology and/or single TRP (sTRP) technology). The communication system supporting the TRP technology may be referred to as a TRP system (e.g., mTRP system and/or sTRP system). In the present disclosure, ‘TRP’ may have a meaning including ‘sTRP’ and/or ‘mTRP’, and ‘TRP’ may refer to ‘sTRP’ or ‘mTRP’ depending on a context. A TRP may refer to an antenna set, antenna group, and/or antenna array. A TRP may be associated with a CORESET and/or a beam (e.g., beam group).

The mTRP technology may fall under a category of MIMO technology. The mTRP may have characteristics (e.g., cell-level characteristics) of macro cells, small cells, pico cells, and/or femto cells. The mTRP may perform data transmission for a terminal. In a case where a channel (e.g., link) with anon-uniform channel condition exists due to an obstacle and/or interference, the mTRP may mitigate the effect caused by the obstacle and/or interference. The mTRP may improve a data transmission rate for a terminal located in a cell edge.

mTRP-based communication may be performed based on a coherent joint transmission (CJT) scheme or a non-coherent joint transmission (NCJT) scheme. In the CJT scheme, a base station may be aware of channel information between each TRP and a terminal and may perform a preprocessing operation for data based on the channel information. In this case, an overhead caused by a transmission procedure of the channel information may increase, and synchronization constraints among the TRPs may occur. In the NCJT scheme, a base station may not need to be aware of channel information between each TRP and a terminal. The mTRP may transmit data to the terminal without performing a preprocessing operation such as phase compensation. The complexity of the NCJT scheme may be lower than the complexity of the CJT scheme.

NCJT-based mTRP communication may be performed based on a single-DCI scheme or a multi-DCI scheme. In the single-DCI scheme, PDSCHs transmitted by mTRP may be scheduled by a single DCI. The single DCI may be transmitted by one TRP of the mTRP. In the multi-DCI scheme, a PDSCH transmitted by each TRP may be scheduled by a DCI transmitted by the corresponding TRP. For example, a first PDSCH transmitted by a first TRP may be scheduled by a first DCI transmitted by the first TRP, and a second PDSCH transmitted by a second TRP may be scheduled by a second DCI transmitted by the second TRP. In other words, a plurality of PDSCHs may be scheduled using a plurality of DCIs.

In the single SCI scheme, a terminal may expect to receive PDSCHs transmitted by different TRPs through different layers while using the same time and frequency resource. Alternatively, the terminal may expect to receive PDSCHs transmitted by different TRPs through different time resources (e.g., different time regions) while using the same frequency resource and the same layer. Alternatively, the terminal may expect to receive PDSCHs transmitted by different TRPs through different frequency resources (e.g., different frequency regions) while using the same time resource and the same layer.

In the multi-DCI scheme, PDSCH scheduling for each TRP may be performed by an individual DCI. PDSCHs scheduled by a plurality of DCIs may be fully overlapped or partially overlapped. Alternatively, PDSCHs scheduled by a plurality of DCIs may not be overlapped. In both the single-DCI scheme and the multi-DCI scheme, the DCI may include transmission configuration indicator (TCI) state information for PDSCH(s).

An indication/configuration of a TCI state for a terminal may be interpreted as an indication/configuration of a beam (e.g., a transmission beam and/or a reception beam). In other words, the TCI state may have a meaning corresponding to the beam. From the perspective of downlink (DL) communication, configuration of a TCI state may refer to configuration of a quasi-co-location (QCL). From the perspective of uplink (UL) communication, configuration of a TCI state may refer to configuration of a spatial filter. A unified TCI state may indicate (e.g., configure) a common beam regardless of DL communication and UL communication. Alternatively, a unified TCI state may indicate (e.g., configure) a common beam for each of DL communication and UL communication. The unified TCI may be referred to as ‘UTCI’.

To enhance the reliability and/or robustness of mTRP communication, improvements such as PDCCH enhancements may be applied. Deployment scenarios for PDCCH enhancement may be classified into a single frequency network (SFN) and a non-SFN.

In the SFN scheme, different TRPs or different panels may transmit the same PDCCH using the same resource (e.g., the same time resource, the same frequency resource, and/or the same spatial resource). In other words, all TRPs or all panels may transmit the PDCCH using the same DMRS configuration, the same DMRS position, and/or the same DMRS sequence. In this case, from the reception perspective for the TRPs or panels, TCI states may be implicitly configured differently.

The above-described exemplary embodiment may be performed based on a plurality of TCI states of a CORESET. Synchronization constraints for an ideal backhaul or a near-ideal backhaul among the TRPs may exist.

In the NSFN scheme, PDCCHs generated by the respective TRPs may be multiplexed in the time domain and/or the frequency domain, and the multiplexed PDCCHs may be transmitted to the terminal. This scheme may be an mTRP-based PDCCH repetition scheme. In the NSFN scheme, the number of encoded bits equal to the number of bits delivered through one PDCCH generated in each TRP may be divided among the TRPs, and the TRP-specific bits (e.g., encoded bits) may be transmitted through a different PDCCH candidate for each TRP. This scheme may correspond to an sTRP-based PDCCH transmission scheme.

In the mTRP-based PDCCH repetition scheme, a PDCCH may be duplicated according to the number of TRPs, and the PDCCHs may be transmitted in the same search spaces (e.g., search spaces having the same index) within different search space sets, each having the same number of PDCCH candidates. In this case, the search space sets may exist within the same CORESET or within different CORESETs. Since one TCI state may be associated with each CORESET, when PDCCHs are transmitted from different search spaces within the same CORESET, only one TCI state for the PDCCHs transmitted from the different search spaces may be indicated (e.g., configured). In this case, the terminal may receive one PDCCH from one TRP at a specific time.

When the PDCCHs are transmitted from the same search spaces within different CORESETs, the terminal may implicitly expect to receive the PDCCH from sTRP or mTRP depending on the number of TCI states (e.g., TCI states indicated or configured by the base station). In this case, a single PDCCH may be divided into as many PDCCHs as the number of TRPs, and the divided PDCCHs may be transmitted in different PDCCH candidates. In this case, an aggregation level and a combined aggregation level may be the same. In the above exemplary embodiment, the PDCCH candidates may be allocated to different CORESETs. A payload size for a combination of finally distributed PDCCHs may be the same as a payload size of a PDCCH transmitted from sTRP. Accordingly, in terms of decoding complexity, the sTRP-based PDCCH transmission scheme may be more advantageous than the mTRP-based PDCCH repetition scheme.

A terminal may perform mTRP communication or sTRP communication with a base station. The mTRP communication between the terminal and the base station may be performed via mTRP associated with the base station. The sTRP communication between the terminal and the base station may be performed via sTRP associated with the base station. The mTRP communication may be referred to as first TRP communication, and the sTRP communication may be referred to as second TRP communication. Alternatively, the mTRP communication may be referred to as second TRP communication, and the sTRP communication may be referred to as first TRP communication. The expression ‘A terminal performs first TRP communication with a base station’ may mean that the terminal performs mTRP communication or sTRP communication with the base station via one or more TRPs associated with the base station. The expression “A terminal performs second TRP communication with a base station” may mean that “the terminal performs sTRP communication or mTRP communication with the base station via one or more TRPs associated with the base station”.

In a communication system, a united TCI framework may be supported. A base station may transmit information of a pool (e.g., pool list) of TCI states to a terminal using RRC signaling. The terminal may receive the information of the pool (e.g., pool list) of TCI states through the RRC signaling of the base station. The base station may configure type information of TCI states for the terminal. The type information may indicate a joint DL/UL beam indication or a separate DL/UL beam indication. The joint DL/UL beam indication may be referred to as ‘joint indication’ or ‘joint type’. The separate DL/UL beam indication may be referred to as ‘separate indication’ or ‘separate type’.

When the joint type (e.g., joint indication) is configured, a TCI state (e.g., one TCI state) for DL and UL may be configured. In other words, a DL TCI state configuration and a UL TCI state configuration may be the same. The terminal may expect that a TCI state indicated by an information element included in PDSCH configuration information is applied to both DL (e.g., DL signal/channel) and UL (e.g., UL signal/channel). The term ‘signal/channel’ may refer to a signal and/or a channel. When the separate type (e.g., separate indication) is configured, TCI states for DL and UL, respectively, may be configured. In other words, a DL TCI state configuration may be distinguished from a UL TCI state configuration. The terminal may expect that a UL TCI state indicated by an information element included in UL BWP configuration information is applied to UL (e.g., UL signal/channel). A UL signal/channel may include PUSCH, PUCCH, and/or SRS.

After the pool (e.g., pool list) of TCI states is configured (e.g., indicated) by RRC signaling, the base station may indicate TCI state(s) (e.g., application of the TCI state(s)) using DCI (e.g., DCI signaling). Due to the constraint of the DCI size (e.g., bits of DCI fields), the base station may preferentially activate candidate TCI state(s) using MAC signaling (e.g., MAC CE signaling). In other words, candidate TCI states, up to a certain number (e.g., a maximum number) that can be indicated or configured through DCI, may be preferentially activated by a MAC CE.

For the activated candidate TCI state(s), DCI may include a codepoint corresponding to a single TCI state or two TCI states according to a TCI state type (e.g., joint type or separate type). When the joint type is configured, a codepoint corresponding to a single TCI state may be delivered by the DCI. When the separate type is configured, a codepoint corresponding to two TCI states may be delivered by the DCI. A unified TCI (e.g., unified TCI framework) designed for sTRP operation (e.g., sTRP communication) may be applied (e.g., extended) to mTRP operation (e.g., mTRP communication).

The unified TCI state framework may be configured (e.g., applied) to sTRP and mTRP operations. A switching operation (e.g., dynamic switching operation) between sTRP operation and mTRP operation may be supported. The switching operation between sTRP operation and mTRP operation may be referred to as a ‘TRP switching operation’. The TRP switching operation may refer to ‘switching operation from mTRP operation to sTRP operation’, ‘switching operation from sTRP operation to mTRP operation’, and/or ‘switching operation from a specific TRP operation to another TRP operation’. For configuration of a TCI state of a PDSCH, a TCI selection field may be introduced. DCI may include the TCI selection field. The TCI selection field may be used not only for configuration of a reception beam (e.g., TCI state) of the PDSCH in the terminal but also for a TRP switching operation (e.g., indication of the TRP switching operation). TRP switching operations may be required not only for PDSCH but also for other signals/channels. A TCI field included in DCI may be used for configuration of TCI state(s) and/or a TRP switching operation (e.g., indication of the TRP switching operation). In other words, the TCI field included in DCI may or may not be used for the TRP switching operation.

The base station may actively select (e.g., use) an sTRP operation or an mTRP operation according to a channel environment. In this case, the efficiency of resource usage may be improved. TRP switching operations may be required not only for PDSCH but also for other signals/channels (e.g., other DL signals/channels). The field(s) included in DCI may be used for the TRP switching operation. The base station may transmit TRP switching indication information to the terminal. A processing delay required for the terminal to transmit or receive a physical channel and/or a time required for beam management in the base station and/or the terminal may exist. A signaling method of a TRP switching indication considering the processing delay time and/or the beam management time may be required.

In mTRP communication, the base station may configure the unified TCI state framework to the terminal. In this situation, a TRP switching operation between mTRP communication and sTRP communication may be supported. A TCI field included in DCI may not be usable for indication/configuration of the TRP switching operation. In this case, a separate signaling method for indication/configuration of the TRP switching operation may be required. In other words, a physical channel for delivery of information (e.g., related information) required for indication/configuration of the TRP switching operation may be required. Configuration for an sTRP communication may be performed. After the configuration for the sTRP communication or simultaneously with the configuration for the sTRP communication, a TRP switching operation from sTRP communication to mTRP communication may be indicated. In this case, a signaling collision may occur, and methods for resolving the signaling collision may be required.

TRP switching information (e.g., TRP switching indication) may be signaled in a channel-common or channel-specific manner. Channel-common TRP switching information may be commonly applied to all channels. Channel-specific TRP switching information may be applied to a specific channel. The TRP switching information may refer to a TRP switching configuration. The terminal may or may not support TRP switching operations. The terminal may transmit information on whether the terminal supports TRP switching operations to the base station. The information on whether the terminal supports TRP switching operations may be included in a UE capability report (e.g., RRC message). The base station may identify whether the terminal supports TRP switching operations based on the information received from the terminal.

When the terminal supports TRP switching operations, the base station may transmit TRP switching information to the terminal. The base station may enable TRP switching operations for the terminal, and the base station may signal a configuration of ‘TRP switching operation=enabled’ to the terminal. When the terminal does not support TRP switching operations, the base station may not transmit TRP switching information to the terminal. The base station may disable TRP switching operations for the terminal, and the base station may signal a configuration of ‘TRP switching operation=disabled’ to the terminal.

In another method, the base station may transmit an RRC message including information indicating enable, layer 2 (L2)-enable, layer 1 (L1)-enable, or disable of TRP switching operations to the terminal. When the information included in the RRC message indicates enable of TRP switching operations, the terminal may determine that TRP switching operations are enabled. When the information included in the RRC message indicates L2-enable of TRP switching operations, the terminal may expect to receive a MAC CE including information indicating enable of TRP switching operations. When the MAC CE including the information indicating enable of TRP switching operations is received, the terminal may determine that TRP switching operations are enabled. When the information included in the RRC message indicates L1-enable of TRP switching operations, the terminal may expect to receive DCI including information indicating enable of TRP switching operations. When the DCI including the information indicating enable of TRP switching operations is received, the terminal may determine that TRP switching operations are enabled. When the information included in the RRC message indicates disable of TRP switching operations, the terminal may determine that TRP switching operations are disabled.

TRP switching information may be transmitted in a UE-specific manner. Among information elements required for a TRP switching operation, some information elements may be cell-common information elements. The base station may transmit the cell-common information elements to the terminal using SI signaling and/or RRC signaling. Operations of the terminal and/or the base station for a TRP switching indication according to a scenario may be as follows.

Scenario #1: a container required for transmission of TRP switching information (e.g., TRP switching indication, TRP switching configuration, TRP switching offset, information required for TRP switching, information related to TRP switching)

In Scenario #1, when a TRP switching operation is required, a configuration method of TRP switching information and/or a physical signal/channel used for transmission of the TRP switching information are described. The TRP switching information may include information element(s) required for a TRP switching operation. For example, the TRP switching information may include at least one of a TRP switching indication, a TRP switching offset (e.g., TRP switching time), a TRP switching configuration, information required for TRP switching, or information related to TRP switching. The TRP switching offset may refer to a time offset from a time when the TRP switching information is received to a time when a TRP switching operation is performed. The time offset may refer to a time required for the TRP switching operation. In other words, the time offset may refer to an application time of the TRP switching operation.

Method #1: the base station may transmit the TRP switching information to the terminal using at least one of a DCI or a MAC CE. The terminal may receive the TRP switching information from the base station. In Method #2, the base station may transmit the TRP switching information to the terminal using an RRC message (e.g., RRC signaling). Method #1 (e.g., DCI and/or MAC CE signaling) may be efficient in terms of signaling overhead and/or latency compared with Method #2 (e.g., RRC signaling). Method #1 may dynamically indicate/configure TRP switching compared with Method #2. Based on Method #1 and Method #2, the base station may transmit the TRP switching information to the terminal using at least one of an RRC message, a MAC CE, or a DCI, and the terminal may receive the TRP switching information through signaling of the base station.

Due to limitations of the DCI size, the DCI may include limited TRP switching information. The MAC CE may include more information elements than the DCI. Latency of MAC CE signaling may be higher than latency of DCI signaling. The MAC CE signaling may be performed following successful DCI signaling.

Considering advantages and disadvantages of physical channels, the TRP switching information may be transmitted according to the following options.
Option #1: the TRP switching information may be transmitted only using a DCI.
Option #2: the TRP switching information may be transmitted only using a MAC CE.
Option #3: the TRP switching information may be transmitted using a combination of a DCI and a MAC CE.

Option #1 may be a DCI-only scheme. Option #2 may be a MAC CE-only scheme. Option #3 may be a DCI-MAC CE combination scheme. The TRP switching information may include a TRP switching indication, and a size of the TRP switching indication may be 1 bit. In this case, a first value (e.g., 0 or 1) of the TRP switching indication may indicate ‘switching from sTRP operation to mTRP operation’, and a second value (e.g., 1 or 0) of the TRP switching indication may indicate ‘switching from mTRP operation to sTRP operation’.

The TRP switching information may include an information element (e.g., follow/unfollow indication) indicating whether the terminal performs an operation according to a TCI selection field included in DCI. In other words, the information element (e.g., follow/unfollow indication) included in the TRP switching information may indicate follow or unfollow of the TCI selection field. The TCI selection field may require dynamic TRP switching for a PDSCH. A first value (e.g., 0 or 1) of the follow/unfollow indication may indicate that the terminal does not follow the TCI selection field. In this case, the terminal may perform an operation according to the number of TRPs associated with a TCI field (e.g., TCI codepoint having a size of 3 bits) included in the DCI. A second value (e.g., 1 or 0) of the follow/unfollow indication may indicate that the terminal follows the TCI selection field. In this case, the terminal may perform an operation according to the TCI selection field included in the DCI. For example, the terminal may perform an operation according to a TRP switching indication for PDSCH reception.

In other words, the terminal (e.g., the terminal and/or the base station) may perform a TRP switching operation for a signal/channel considering TRP switching information for PDSCH reception. When the TCI selection field indicates sTRP-based PDSCH reception and the TRP switching information (e.g., follow/unfollow indication) is set to the first value (e.g., 0 or 1), the terminal may expect to receive not only a PDSCH but also other signals/channels from sTRP. When the TCI selection field indicates mTRP-based PDSCH reception and the TRP switching information (e.g., follow/unfollow indication) is set to the first value (e.g., 0 or 1), the terminal may expect to receive not only a PDSCH but also other signals/channels from mTRP. When the TCI selection field indicates sTRP-based PDSCH reception and the TRP switching information (e.g., follow/unfollow indication) is set to the second value (e.g., 1 or 0), the terminal may not expect to receive other signals/channels (e.g., signals/channels other than a PDSCH) from an sTRP. When the TCI selection field indicates mTRP-based PDSCH reception and the TRP switching information (e.g., follow/unfollow indication) is set to the second value (e.g., 1 or 0), the terminal may not expect to receive other signals/channels (e.g., signals/channels other than a PDSCH) from mTRP. Since the number of bits required for the above-described operation is not large, the TRP switching information may be transmitted based on Option #1 or Option #2.

In TRP switching from mTRP operation to sTRP operation, one TRP among mTRP may be selected (e.g., indicated), and communication based on the one TRP may be performed. When TRP switching from mTRP operation to sTRP operation is indicated, ambiguity about which sTRP among the mTRP performs communication (e.g., transmission/reception operation of signals/channels) with the terminal may occur. For example, the terminal may expect to perform communication with two TRPs using TCI #3 and TCI #5. In this situation, the terminal may receive a TRP switching indication from the base station for TRP switching from mTRP operation to sTRP operation. In this case, ambiguity about which TCI among TCI #3 and TCI #5 the terminal uses may occur. In other words, ambiguity about whether a Rx/Tx beam configuration of the terminal is based on TCI #3 or TCI #5 may occur. When the size of the TRP switching indication is 1 bit, the ambiguity may be problematic.

To solve the ambiguity problem, information for notifying the terminal of which TRP is selected in TRP switching from mTRP operation to sTRP operation may be required. In TRP switching from mTRP operation to sTRP operation, the terminal and/or the base station may expect that communication based on specific TRP(s) is not performed according to a predefined rule.

The TRP switching information (e.g., information element included in the TRP switching information) may indicate ‘switching from sTRP operation to mTRP operation’ or ‘switching from mTRP operation to sTRP operation’ rather than a follow/unfollow indication of the TCI selection field. In TRP switching from mTRP operation to sTRP operation, a TRP or a TRP state associated with a CORESET #0 (e.g., CORESET0) may be predefined as a default TRP or a default TRP state, and the terminal may perform operations based on the default TRP or the default TRP state. In other words, when TRP switching from mTRP operation to sTRP operation is indicated, the terminal and/or the base station may perform communication via the default TRP. In another method, in TRP switching from mTRP operation to sTRP operation, the terminal may perform operations based on a TCI state having the lowest index or the highest index among TCI states (e.g., TCI state codewords) indicated by a TCI field included in DCI. In other words, when TRP switching from mTRP operation to sTRP operation is indicated, the terminal and/or the base station may perform communication via one TRP associated with a TCI state having the lowest index or the highest index among TCI states indicated by the TCI field.

When a separate type for two TRPs is indicated, and a codepoint #o={(DL, UL) for TRP #p, (DL, UL) for TRP #q} is indicated by a TCI field included in DCI, a configuration for TRP #p may be a TCI state having the lowest index, and a configuration for TRP #q may be a TCI state having the highest index. TCI states for multiple TRPs may be included in a TCI state configuration in ascending order or descending order, and a specific TCI state (e.g., a TRP associated with the specific TCI state) may be implicitly indicated. When TCI states for multiple TRPs are included in the TCI state configuration in ascending order, TRP #p may be interpreted as index #0 and TRP #q may be interpreted as index #1. When TCI states for multiple TRPs are included in the TCI state configuration in descending order, TRP #p may be interpreted as index #1 and TRP #q may be interpreted as index #0.

According to a TRP switching indication (e.g., TRP switching information), a switching operation between multiple TRPs (e.g., all available TRPs) and one TRP may be performed. The terminal and/or the base station may perform the TRP switching operation. In other words, the terminal and/or the base station may expect communication with multiple TRPs based on the TRP switching indication. Alternatively, the terminal and/or the base station may expect communication with one TRP based on the TRP switching indication.

The base station may select some TRPs among multiple TRPs (e.g., entire TRPs) and may indicate switching for the some TRPs to the terminal. For example, the terminal may perform communication with four TRPs, and the terminal may receive a TRP switching indication for switching from four TRPs to two or three TRPs from the base station. The TRP switching indication may be included in TRP switching information. The TRP switching indication may be dynamically transmitted. In this case, the base station may indicate (e.g., configure) a TRP switching operation for M TRP(s) using TRP switching information having a size of N bits. Each of N and M may be a natural number equal to or greater than 1. Cases where N=M or N<M may exist.

In a case of N=M, each bit of TRP switching information (e.g., a bitmap included in the TRP switching information) may correspond to (e.g., is associated with or mapped to) each TRP. Each TRP indicated by the TRP switching information may be associated with a TCI state having the lowest index or the highest index in the TCI state configuration indicated by the TCI field included in the DCI. The lowest/highest index in the TCI state configuration may be determined based on ascending order or descending order. For a TRP switching indication for two TRPs (e.g., TRP #1 and TRP #2), TRP switching information (e.g., TRP switching indication) having a size of two bits may be used, and each of the two bits may be associated with each TRP. TCI states in the TCI state configuration indicated by the TCI field included in the DCI may be associated with (TRP #1, TRP #2) or (TRP #2, TRP #1) in an order of lowest index (or highest index).

The base station may indicate (e.g., configure) a TRP group-based switching operation to the terminal. A TRP group may include one or more TRPs. Communication between the base station and the terminal may be performed via two or more TRPs (e.g., a TRP group including the two or more TRPs). When communication between the base station and the terminal is performed using three or more TRPs, signaling overhead for a TRP switching indication may be large. TRPs having similar locations or TRPs located in the same area may be configured as one TRP group. The base station may indicate an ON/OFF state for a TRP group in units of a TRP group. In other words, the base station may indicate a TRP switching operation for a TRP group in units of a TRP group. Communication between the terminal and the base station may be performed via a TRP group (e.g., TRPs belonging to the TRP group) indicated as ON. Communication between the terminal and the base station may not be performed via a TRP group (e.g., TRPs belonging to the TRP group) indicated as OFF. The TRP group-based TRP switching operation may be more efficient than the TRP-based TRP switching operation.

M TRPs may be divided into N TRP groups, and each TRP group may include M/N TRPs. A TRP switching operation for all TRPs belonging to each TRP group may be performed. A TRP switching operation for each TRP group may be dynamically performed. When M is 4 and N is 2, four TRPs may be divided into two TRP groups, each TRP group may include two TRPs, and each TRP group may be mapped to one bit. A first value (e.g., 0 or 1) of a bit may indicate an ON state (e.g., activated state, enabled state) of a TRP group linked to the bit. A second value (e.g., 1 or 0) of a bit may indicate an OFF state (e.g., deactivated state, disabled state) of a TRP group linked to the bit. A state (e.g., ON state or OFF state) of TRPs belonging to a TRP group may be based on a value of a bit mapped to the TRP group. The terminal may perform communication with the base station via TRP group(s) in the ON state. TRP group(s) in the OFF state may not be used for communication between the terminal and the base station.

Information (e.g., distinguishing information, identifying information) of TRP(s) belonging to a TRP group may need to be provided to the terminal. Explicit distinguishing information such as a TRP ID may not exist. Information about which TRPs belong to each TRP group may be required. A definition about use or non-use of TCI states (e.g., TCI configuration) for TRPs for each TRP group may be required. TRPs associated with TCI states (e.g., entire TCI states) indicated by a TCI codepoint (e.g., TCI field) may be configured as a TRP group in descending order or ascending order. TCI states indicated by the codepoint may be based on the joint type or the separate type.

When M is 4, N is 2, and TCI states indicated by a TCI codepoint (e.g., TCI field) are {(DL TCI #2, UL TCI #3), (DL TCI #1, UL TCI #5), (DL TCI #3, UL TCI #2), (DL TCI #4, UL TCI #8)}, a first TRP group may include a TRP associated with (DL TCI #2, UL TCI #3) and a TRP associated with (DL TCI #1, UL TCI #5), and a second TRP group may include a TRP associated with (DL TCI #3, UL TCI #2) and a TRP associated with (DL TCI #4, UL TCI #8). The terminal may expect a TCI configuration based on two bits. A TRP mapping order may be a reverse order of entire TRPs regardless of the TRP groups. A DL TCI may refer to a TCI for DL. A UL TCI may refer to a TCI for UL.

The configuration for TRP switching information (e.g., TRP switching indication) may be applied to exemplary embodiments of the present disclosure. For example, the configuration for TRP switching information may be applied to Method #1 and/or Method #2. Option #3 may be used when the size of TRP switching information is large. The TRP switching information may include not only indication information of a TRP switching operation between mTRP operation and sTRP operation but also information for TRP distinction, and/or indication information of TRP switching for some TRPs among multiple TRPs (e.g., entire TRPs). For example, DCI may include information indicating whether to perform a TRP switching, and a MAC CE may include information of TRPs performing communication with the terminal after the TRP switching operation. Reserved bits included in the DCI may be used to indicate whether to perform the TRP switching operation. Information of the TRPs included in the MAC CE may include ON or OFF indication information for TRPs.

Method #2: the base station may transmit TRP switching information to the terminal using RRC signaling (e.g., an RRC message). The terminal may receive the TRP switching information from the base station.

The terminal may operate in an RRC connected state. According to synchronization problems and/or channel state changes, a change of the RRC connected state may be required. The base station may transmit information related to a change of the RRC connected state to the terminal by using an RRC reconfiguration message among RRC messages. The information related to the change of the RRC connected state may include measurement-related information (e.g., MAC main configuration, physical channel configuration) and/or access stratum (AS) security configuration. The RRC reconfiguration message may be used for addition, change, and/or release of a cell group (e.g., cell, PSCell, PCell). The RRC reconfiguration message may include information of TRPs (e.g., basic information).

When the RRC reconfiguration message includes information of sTRP (hereinafter referred to as ‘sTRP information’), the terminal may expect TRP switching from mTRP operation to sTRP operation based on the information on the sTRP included in the RRC reconfiguration message. When the RRC reconfiguration message includes information of mTRP (hereinafter referred to as ‘mTRP information’), the terminal may expect TRP switching from sTRP operation to mTRP operation based on the information on the mTRP included in the RRC reconfiguration message.

The TRP information (e.g., sTRP information and/or mTRP information) may be included in cell group configuration information, and the RRC reconfiguration message including the cell group configuration information may be transmitted to the terminal. This method may be referred to as Method #2-1. The cell group configuration information may be information of a master cell group (MCG) or a secondary cell group (SCG). Separate information element(s) indicating the TRP information (e.g., sTRP information and/or mTRP information) may be included in the RRC reconfiguration message, and the RRC reconfiguration message may be transmitted to the terminal. This method may be referred to as Method #2-2. The TRP information may refer to ‘sTRP information’. ‘mTRP information’, or ‘sTRP information and mTRP information’.

When Method #2-1 is used, the cell group configuration information may include not only cell information but also the TRP information. The TRP information may include information of TRP(s) associated with a cell (e.g., the number of TRPs, TRP locations), activation information (e.g., activation time) of each TRP, and/or deactivation information (e.g., deactivation time) of each TRP. The activation information of each TRP may refer to ON information for each TRP. The deactivation information of each TRP may refer to OFF information for each TRP. When Method #2-2 is used, the TRP information may be cell-common information, and TRPs may be implicitly indicated. TRPs corresponding to the cell may be mapped in ascending order based on a specific CORESET (e.g., CORESET0). The TRPs may be distinguished by the mapping scheme.

In Method #2-1, the TRP information (e.g., TRP configuration information) may be indicated per cell. In Method #2-2, the same TRP information (e.g., the same TRP configuration information) may be applied to cells. The base station may transmit the RRC reconfiguration message including the cell group configuration information to the terminal. In this case, according to Method #2-1, the TRP information (e.g., ON/OFF information for each TRP) associated with each serving cell may be included in the RRC reconfiguration message together with the cell group configuration information. The cell group configuration information may include information of an MCG/SCG and/or individual information (e.g., separate information) of each serving cell belonging to (e.g., associated with) the MCG/SCG. For example, the cell group configuration information may include a serving cell index (ID), physical cell ID (PCI), DL channel configuration information, and/or UL channel configuration information.

When a TCI state is configured per serving cell, TRP(s) associated with a single serving cell may follow the same TCI state configuration. An ON/OFF state may be differently configured per serving cell. The ON/OFF state may refer to activation/deactivation of a corresponding TRP. ON/OFF indication may be configured in a bitwise form. The size of the ON/OFF indication may correspond to the number of configured TRPs. In this case, the ON/OFF (e.g., TRP switching indication) may be configured as cell group-specific or cell group-common. In other words, a configuration for a TRP switching operation may be a cell group-specific configuration or a cell group-common configuration. A TRP switching operation based on a cell group-specific configuration or a cell group-common configuration may be performed in a UE-specific manner. ON/OFF indication (e.g., TRP switching indication) and/or TRP information corresponding to all cell groups regardless of cell group units or MCG/SCG may be included in the RRC reconfiguration message.

Among two TRPs (e.g., a first TRP and a second TRP) belonging to an MCG, an information element indicating ON of one TRP may be transmitted to the terminal. A first value (e.g., 10) of the information element may indicate ON of the first TRP. A second value (e.g., 01) of the information element may indicate ON of the second TRP. TRPs associated with all cells belonging to a cell group may follow the rule (e.g., above-described method). When the base station has one TRP, the terminal may ignore the indication (e.g., ON/OFF indication). When the base station has three or more TRPs, the terminal may apply the ON/OFF indication to TRPs selected based on the lowest TRP index or the highest TRP index.

Signaling overhead and/or additional signaling delay for Method #2 may be greater than signaling overhead and/or additional signaling delay for Method #1. Therefore, according to Method #2, dynamic TRP switching indication may not be possible. Method #2 may be used in an environment in which dynamic TRP switching is not required.

When the number of information elements required for TRP switching (e.g., dynamic TRP switching) is large and/or when time-invariant information elements exist among the information elements, a DCI and/or a MAC CE may include TRP ON/OFF information (e.g., bit(s) indicating TRP ON/OFF), and other information elements as well as the TRP ON/OFF information may be included in an RRC message. According to the above-described method, the problem of limited resources for Method #1 may be solved, and the problem of signaling overhead and/or signaling delay for Method #2 may be solved. The RRC message may be an RRC reconfiguration message, an RRC resume message, and/or an RRC reestablishment message. Since TRP switching is linked to a cell and/or a unified TCI, the RRC message may include cell group configuration information and/or configuration information of unified TCI states.

The configuration for TRP switching information (e.g., TRP switching indication) may be applied to exemplary embodiments of the present disclosure. For example, the configuration for TRP switching information may be applied to Method #1 and/or Method #2.

Scenario #2: operations of a communication node (e.g., a base station and/or a terminal) due to misalignment between a TCI codepoint (e.g., TCI field) included in DCI and TRP switching information (e.g., TRP switching indication, TRP switching configuration, TRP switching offset, information required for TRP switching, information related to TRP switching).

The base station may configure TCI state(s) using a TCI field included in DCI. A size of the TCI field may be 3 bits. The TCI field may indicate one candidate TCI state pool list among TCI state pools (e.g., eight candidate TCI state pool lists) configured by RRC signaling. Regardless of whether a TRP switching operation (e.g., dynamic TRP switching operation) is performed, TCI state(s) for mTRP or sTRP may be configured. TRP switching information (e.g., dynamic TRP switching indication) may be transmitted through signaling according to Scenario #1 independently of configuration/indication of TCI states.

The TCI state configuration and TRP switching information may be independent of each other. Therefore, a conflict between the TCI state configuration and TRP switching information may occur. For example, the base station may transmit DCI including a TCI field indicating TCI states for two TRPs to the terminal. The base station may transmit DCI including a field (e.g., TRP switching indication) indicating TRP switching from mTRP operation to sTRP operation to the terminal. The TRP switching indication may be signaled based on Method #1 in Scenario #1. The TCI field and the TRP switching indication may be included in the same DCI. Alternatively, the TCI field and the TRP switching indication may be included in different DCIs. The terminal may receive DCI(s) from the base station and may identify the TCI field and the TRP switching indication included in the DCI(s).

Since the TCI field indicates mTRP operation (e.g., communication based on two TRPs), and the TRP switching indication indicates sTRP operation, a conflict between the TCI field and the TRP switching indication may occur. In this case, ambiguity regarding TRP operation (e.g., mTRP operation or sTRP operation) may occur in the terminal. To resolve the ambiguity problem, configuration of (e.g., indication) the TCI field and the TRP switching indication together may be prohibited. The base station may match the number of TRPs required for communication in implementation. By the operation, the conflict problem between the TCI field and the TRP switching indication may be resolved.

The TRP switching indication may be transmitted by a MAC CE or an RRC message instead of DCI. For example, while the terminal performs communication (e.g., DL communication or UL communication) based on the TCI configuration (e.g., TCI configuration according to the TCI field included in the DCI), the terminal may receive a MAC CE or an RRC message including the TRP switching indication from the base station.

A repeated transmission operation may be configured to the terminal. The repeated transmission operation may refer to a repeated PDSCH transmission operation and/or a repeated PUSCH transmission operation. The terminal may perform a PDSCH reception operation according to the repeated PDSCH transmission operation or may perform a PUSCH transmission operation according to the repeated PUSCH transmission operation. While the terminal performs the repeated transmission operation, the terminal may receive a TRP switching indication (e.g., TRP switching information) from the base station. The TRP switching indication may be signaled based on Scenario #1. In this situation, the terminal may operate as follows.

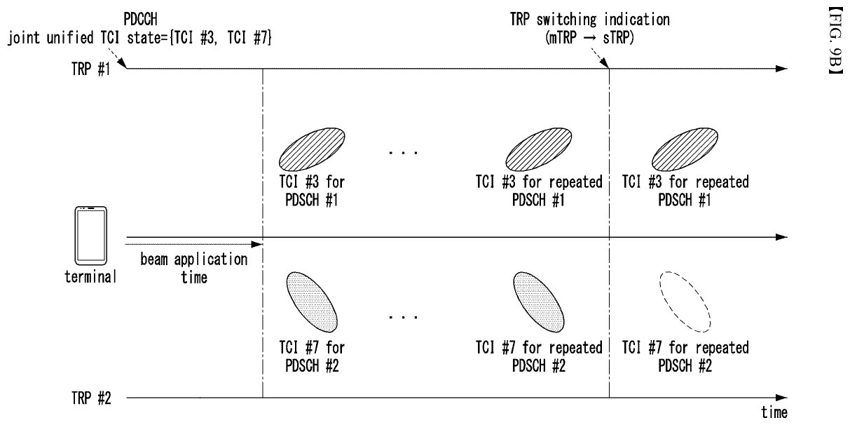

FIG. 9A is a conceptual diagram illustrating operation methods of a terminal in a situation in which a TCI configuration and a TRP switching indication conflict.

As shown in FIG. 9A, the terminal may receive a PDSCH based on a TCI configuration in resources configured for repeated PDSCH transmission. The TCI configuration may be indicated by a TCI field included in DCI. The TCI configuration may indicate a joint unified TCI state={TCI #3, TCI #7}. The TCI configuration may be based on the joint type. While the PDSCH reception operation is performed, the terminal may receive information (e.g., TRP switching indication) indicating a TRP switching operation from mTRP communication to sTRP communication from the base station. When the repeated PDSCH transmission operation is not completed, the terminal may ignore the TRP switching indication. In other words, even when the TRP switching indication is received, the terminal may receive the PDSCH based on the TCI configuration in resources configured for repeated PDSCH transmission. After the repeated PDSCH transmission operation is completed, the terminal may perform sTRP communication based on the TRP switching indication. In this case, an application time of the TRP switching indication may be delayed to until after a completion time of the repeated PDSCH transmission operation. Alternatively, the terminal may perform sTRP communication based on the TRP switching indication after an application time of the TRP switching operation from a reception time of the TRP switching indication. In this case, sTRP communication based on the TRP switching indication may be performed even before completion of the repeated PDSCH transmission operation.

FIG. 9B is a conceptual diagram illustrating operation methods of a terminal in a situation in which a TCI configuration and a TRP switching indication conflict.

As shown in FIG. 9B, the terminal may receive a PDSCH based on a TCI configuration in resources configured for repeated PDSCH transmission. The TCI configuration may be indicated by a TCI field included in DCI. The TCI configuration may indicate a joint unified TCI state={TCI #3, TCI #7}. The TCI configuration may be based on the joint type. While the PDSCH reception operation is performed, the terminal may receive information (e.g., TRP switching indication) indicating a TRP switching operation from mTRP communication to sTRP communication from the base station. The terminal may perform sTRP communication based on the TRP switching indication after a reception time of the TRP switching indication. In other words, the terminal may not expect to perform mTRP communication after the reception time of the TRP switching indication.

When a separate time (e.g., beam sweeping time, beam switching time) is required for the TRP switching operation, the exemplary embodiment of FIG. 9A may be used. When a separate time (e.g., beam sweeping time, beam switching time) is not required for the TRP switching operation, the exemplary embodiment of FIG. 9B may be used. In the exemplary embodiment of FIG. 9B, since an application time of the TRP switching indication is not required, the terminal may perform sTRP communication based on the TRP switching indication. Thereafter, when TRP switching from sTRP communication to mTRP communication is indicated, the terminal may expect to perform mTRP communication based on an existing TCI state (e.g., existing TCI configuration). The mTRP communication may be performed through sTRP and an additional TRP. The existing TCI state may refer to a TCI state before deactivation. Alternatively, the existing TCI state may refer to a TCI state for mTRP communication before the TRP switching operation from mTRP communication to sTRP communication.

Scenario #3: application of TRP switching (e.g., dynamic TRP switching) per channel (or signal)

In Scenarios #1 and #2, TRP switching information (e.g., TRP switching indication) may be applied in a channel-common manner. In other words, in Scenarios #1 and #2, TRP switching information may be commonly applied to all channels (e.g., all channels and/or all signals). For example, TRP communication for all channels may be switched to sTRP communication or mTRP communication by TRP switching information. In Scenario #3, TRP switching information may be applied to a specific channel and/or a specific signal. When a state (e.g., environment) of a specific channel is not good, gain compared with consumed power and/or consumed resources for TRP communication for the specific channel may be small. Even though gain compared with consumed power and/or consumed resources for TRP communication for the specific channel is small, transmission of the specific channel may be required. In this situation, Scenario #3 may be required.

A signaling method of TRP switching information in Scenario #3 may be the same as or similar to a signaling method of TRP switching information in Scenario #1 and/or Scenario #2. In Scenario #3, TRP switching information may be applied to specific channels (e.g., specific channels and/or specific signals) instead of all channels (e.g., all channels and/or all signals). In the present disclosure, a channel may be interpreted as ‘channel’, ‘signal’, or ‘channel and signal’ according to a context. Information (e.g., indication information and/or configuration information) for specific channels to which TRP switching information is applied may be signaled to the terminal. The information for the specific channels may include information for selection of the specific channels.

As a first method, the base station may transmit an RRC message including a TRP switching indication and information of channel(s) to which the TRP switching indication is applied to the terminal. The information of channel(s) to which the TRP switching indication is applied may be referred to as ‘channel indication information’. The terminal may receive the RRC message from the base station, and the terminal may identify the TRP switching indication and the channel(s) to which the TRP switching indication is applied based on the information included in the RRC message. The channel indication information may be configured in a bitwise form or a bitmap form. Each bit of the channel indication information may be mapped to one channel or one channel group. A channel group may be classified into a DL channel group and a UL channel group. A mapping relationship between bits of the channel indication information and channels (or channel groups) may be predefined. For example, the base station may transmit an RRC message including information of the mapping relationship between bits of the channel indication information and channels (or channel groups) to the terminal. The terminal may identify the information of the mapping relationship indicated by RRC signaling of the base station.

A first value (e.g., 0 or 1) of a bit included in the channel indication information may indicate an ON state (e.g., activated state) of a channel or a channel group mapped to the bit. A TRP switching operation may be applied to the channel or the channel group in the ON state. A second value (e.g., 1 or 0) of a bit included in the channel indication information may indicate an OFF state (e.g., deactivated state) of a channel or a channel group mapped to the bit. A TRP switching operation may not be applied to the channel or the channel group in the ON state. RRC signaling may not be as dynamic as DCI signaling and/or MAC CE signaling. RRC signaling may deliver more information elements than DCI signaling and/or MAC CE signaling.

As a second method, the base station may transmit a DCI or a MAC CE including information (e.g., channel indication information) of channel(s) to which the TRP switching indication is applied to the terminal. The TRP switching information (e.g., TRP switching indication) may be transmitted through at least one of an RRC message, a MAC CE, or a DCI. The channel indication information may be configured in a bitwise form or a bitmap form. Each bit of the channel indication information may be mapped to one channel or one channel group. A mapping relationship between bits of the channel indication information and channels (or channel groups) may be predefined. For example, the base station may transmit an RRC message including information of the mapping relationship between bits of the channel indication information and channels (or channel groups) to the terminal. The terminal may identify the information of the mapping relationship indicated by RRC signaling of the base station.

For example, a size of the channel indication information may be 6 bits. The 6 bits of the channel indication information may be mapped to {PDSCH, PDCCH, CSI-RS, PUSCH, PUCCH, SRS}. The 6 bits of the channel indication information may be mapped to {PDSCH, PDCCH, CSI-RS, PUSCH, PUCCH, SRS} from a lowest bit. Information of a mapping relationship between each bit of the channel indication information and a channel/signal may be signaled to the terminal through at least one of an RRC message, a MAC CE, or a DCI. The terminal may perform sTRP communication or mTRP communication for a specific channel (e.g., specific signal) based on the channel indication information (e.g., TRP switching indication and channel indication information).

In another example, a size of the channel indication information may be 3 bits. Each of the 3 bits of the channel indication information may be mapped to a channel. The base station may signal information of a mapping relationship between each bit of the channel indication information and a channel/signal to the terminal through at least one of an RRC message, a MAC CE, or a DCI. The base station may transmit a DCI or a MAC CE including channel indication information and/or a TRP switching indication to the terminal. The TRP switching indication may indicate whether a TRP switching operation is performed. The channel indication information may indicate channel(s) and/or signal(s) to which TRP switching is applied. The terminal may receive information of the mapping relationship, channel indication information, and/or TRP switching indication from the base station, and based on the received information, the terminal may perform sTRP communication or mTRP communication for a specific channel (e.g., a specific signal).

According to exemplary embodiments of the present disclosure, the base station and/or the terminal may perform a TRP switching operation based on TRP switching information and may perform communication via mTRP or sTRP. Exemplary embodiments of the present disclosure may be applied to a unified TCI framework and/or a general TCI framework. Exemplary embodiments of the present disclosure may be applied to mTRP dynamic switching and/or sTRP dynamic switching. Exemplary embodiments of the present disclosure may be applied to a licensed band and/or an unlicensed band. A panel switching operation, an antenna element (AE) switching operation, and/or an AE group switching operation of the terminal may be performed in the same or similar manner as exemplary embodiments (e.g., TRP switching operation) of the present disclosure. In other words, exemplary embodiments of the present disclosure may be applied to a panel switching operation, an AE switching operation, and/or an AE group switching operation of the terminal.

Exemplary embodiments of the present disclosure (e.g., TRP switching operation) may or may not be performed depending on situations of the base station and/or the terminal. Exemplary embodiments of the present disclosure (e.g., TRP switching operation) may be performed considering a beam switching operation (e.g., dynamic beam switching operation), TRP switching time, and the like. Conditions for performing a TRP switching operation may be predefined. For example, the base station may inform the terminal of information of conditions for performing a TRP switching operation. The terminal may acquire information of conditions for performing a TRP switching operation from the base station. When a TRP switching operation satisfies the conditions, the base station and/or the terminal may perform the TRP switching operation.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a user equipment (UE), comprising:
performing a first transmission reception point (TRP) communication with a base station;
receiving TRP switching information from the base station;
performing a TRP switching operation from the first TRP communication to a second TRP communication based on the TRP switching information; and
performing the second TRP communication with the base station,
wherein, when the first TRP communication is multiple-TRP (mTRP) communication, the second TRP communication is single-TRP (sTRP) communication, and when the first TRP communication is sTRP communication, the second TRP communication is mTRP communication.

2. The method of claim 1, wherein the TRP switching information is received through at least one of a radio resource control (RRC) message, a medium access control (MAC) control element (CE), or downlink control information (DCI).

3. The method of claim 1, wherein the TRP switching operation from the first TRP communication to the second TRP communication is performed in a UE-specific manner, and a configuration for the TRP switching operation is a cell group-common configuration or a cell group-specific configuration.

4. The method of claim 1, wherein the TRP switching operation from the first TRP communication to the second TRP communication is performed in a channel-common manner or a channel-specific manner.

5. The method of claim 1, further comprising: transmitting information indicating whether the UE supports the TRP switching operation to the base station.

6. The method of claim 1, further comprising: receiving, from the base station, information indicating enable, layer 1 (L1)-enable, layer 2 (L2)-enable, or disable of the TRP switching operation,
wherein the L1-enable indicates that the TRP switching operation is enabled by a DCI, and the L2-enable indicates that the TRP switching operation is enabled by a MAC CE.

7. The method of claim 1, wherein the TRP switching information includes a TRP switching indication, a first value of the TRP switching indication indicates a TRP switching operation from mTRP communication to sTRP communication, and a second value of the TRP switching indication indicates a TRP switching operation from sTRP communication to mTRP communication.

8. The method of claim 1, wherein the TRP switching information includes a bitmap, each bit of the bitmap is mapped to one TRP or a TRP group, a first value of each bit indicates an ON state of a TRP or a TRP group mapped to each bit, a second value of each bit indicates an OFF state of a TRP or a TRP group mapped to each bit, and a TRP group includes a plurality of TRPs.

9. The method of claim 1, wherein the TRP switching information includes a follow/unfollow indication, a first value of the follow/unfollow indication indicates that the second TRP communication follows an indication of a transmission configuration indicator (TCI) selection field included in a DCI received from the base station, and a second value of the follow/unfollow indication indicates that the second TRP communication does not follow the indication of the TCI selection field included in the DCI received from the base station.

10. The method of claim 1, wherein the TRP switching information includes a TRP switching offset, and the second TRP communication is performed after the TRP switching offset from a time of receiving the TRP switching information.

11. The method of claim 1, wherein the TRP switching information includes channel indication information, the TRP switching operation from the first TRP communication to the second TRP communication is applied to a channel indicated as ON by the channel indication information, and is not applied to a channel indicated as OFF by the channel indication information.

12. The method of claim 1, wherein when a TRP switching operation from mTRP communication to sTRP communication is indicated, the sTRP communication is performed via a TRP associated with a control resource set (CORESET) 0.

13. The method of claim 1, wherein when a TRP switching operation from mTRP communication to sTRP communication is indicated, the sTRP communication is performed via a TRP associated with a TCI state having a lowest or highest index among TCI states indicated by a TCI field included in a DCI received from the base station.

14. A method of a base station, comprising:
performing first transmission reception point (TRP) communication with a user equipment (UE);
transmitting TRP switching information to the UE;
performing a TRP switching operation from the first TRP communication to a second TRP communication based on the TRP switching information; and
performing the second TRP communication with the UE,
wherein when the first TRP communication is multiple-TRP (mTRP) communication, the second TRP communication is single-TRP (sTRP) communication, and when the first TRP communication is sTRP communication, the second TRP communication is mTRP communication.

15. The method of claim 14, wherein the TRP switching information is transmitted through at least one of a radio resource control (RRC) message, a medium access control (MAC) control element (CE), or downlink control information (DCI).

16. The method of claim 14, further comprising: receiving, from the UE, information indicating whether the UE supports the TRP switching operation, wherein when the UE supports the TRP switching operation, the TRP switching information is transmitted to the UE.

17. The method of claim 14, wherein the TRP switching information includes a TRP switching indication, a first value of the TRP switching indication indicates a TRP switching operation from mTRP communication to sTRP communication, and a second value of the TRP switching indication indicates a TRP switching operation from sTRP communication to mTRP communication.

18. The method of claim 14, wherein the TRP switching information includes a bitmap, each bit of the bitmap is mapped to one TRP or a TRP group, a first value of each bit indicates an ON state of a TRP or a TRP group mapped to each bit, a second value of each bit indicates an OFF state of a TRP or a TRP group mapped to each bit, and a TRP group includes a plurality of TRPs.

19. The method of claim 14, wherein when a TRP switching operation from mTRP communication to sTRP communication is indicated, the sTRP communication is performed via a TRP associated with a control resource set (CORESET) 0.

20. The method of claim 14, wherein when a TRP switching operation from mTRP communication to sTRP communication is indicated, the sTRP communication is performed via a TRP associated with a TCI state having a lowest or highest index among TCI states indicated by a TCI field included in a DCI received from the base station.
